(19) United States
(12) Patent Application Publication
(10) Pub. No.: US 2018/0373075 A1
(43) Pub. Date: Dec. 27, 2018

(54) DOUBLE SIDED DISPLAY, DISPLAY DEVICE AND ELECTRONIC EQUIPMENT

(71) Applicant: BOE TECHNOLOGY GROUP CO., LTD., Beijing (CN)

(72) Inventors: Hongfei CHENG, Beijing (CN); Xin LI, Beijing (CN)

(21) Appl. No.: 15/736,982

(22) PCT Filed: Jun. 7, 2017
(86) PCT No.: PCT/CN2017/087412

§ 371 Date: Dec. 15, 2017

(30) Foreign Application Priority Data
Jun. 24, 2016 (CN) 201610473477.0

(51) Int. Cl. G02F 1/1343; G06F 3/14; G02F 1/1334; G02F 1/1333

(52) U.S. Cl. CPC G02F 1/1343; G06F 3/1423; G02F 2201/123; G02F 1/133308; G02F 2201/121; G02F 1/1334

(57) ABSTRACT

A double sided display includes two liquid crystal display panels. When the pixel electrode and the common electrode are in an on state, they form an electric field which causes the liquid crystal molecules to deflect. Due to the effect of a polymer network, the liquid crystal polymer is in a scattering state, which will destroy the condition of total reflection between the two substrates for light from the backlight source. As a result, at least a part of light from the backlight source is emitted from a side of the first substrate after being scattered by the liquid crystal polymer. When the pixel electrode and the common electrode are in the off state, the long axis direction of liquid crystal molecules is consistent with the extension direction of the polymer long chains in the liquid crystal polymer, and the liquid crystal polymer is in a transparent state.

### RELATED APPLICATION

The present application claims the benefit of Chinese Patent Application No. 201610473477.0, filed on Jun. 24, 2016, the entire disclosures of which are incorporated herein by reference.

### TECHNICAL FIELD

The present disclosure relates to the technical field of display, in particular to a double sided display, a display device and an electronic equipment.

### BACKGROUND

A liquid crystal display generally includes an upper substrate and a lower substrate, a liquid crystal layer disposed between the upper substrate and the lower substrate, a pixel electrode and a common electrode for generating electric fields at both sides of the liquid crystal layer, an upper polarizer at an outer side of the upper substrate, a lower polarizer at an outer side of the lower substrate, and a backlight source.

With the development of display technologies, transparent displays based on liquid crystal displays have gained more and more attention. However, the existing transparent liquid crystal displays have the problem of low transparency, especially when they are used in transparent double sided displays, the transparency is even lower.

### SUMMARY

An embodiment of the present disclosure provides a double sided display, a display device and an electronic equipment for improving transmittance and light efficiency of the display.

A double sided display provided by an embodiment of the present disclosure comprises two liquid crystal display panels laminated on each other with their light exit sides facing away from each other, and a side-emitting backlight source for providing light for each of the liquid crystal display panels. Each liquid crystal display panel comprises: a first substrate and a second substrate arranged opposite to each other, a liquid crystal polymer located between the first substrate and the second substrate, a pixel electrode and a common electrode insulated from each other; wherein the liquid crystal polymer comprises polymer long chains arranged along an extension direction; when the pixel electrode and the common electrode are in an off state, a long axis direction of liquid crystal molecules in the liquid crystal polymer is consistent with the extension direction of the polymer long chains; when the pixel electrode and the common electrode are in an on state, an electric field is formed by the pixel electrode and the common electrode, and the liquid crystal polymer is in a scattering state under the effect of the electric field, so that at least a part of light from the backlight source is emitted from a side of the first substrate after being scattered by the liquid crystal polymer, wherein the side of the first substrate is a light exit side of the liquid crystal display panel.

Optionally, in the double sided display provided in the embodiment of the present disclosure, in at least one of the liquid crystal display panels, the pixel electrode and the common electrode are respectively located at both sides of the liquid crystal polymer. Liquid crystals in the liquid crystal polymer are positive liquid crystals, and when the pixel electrode and the common electrode are in the off state, the long axis direction of the liquid crystal molecules in the liquid crystal polymer are perpendicular to a cell gap direction of the liquid crystal display panel. Alternatively, liquid crystals in the liquid crystal polymer are negative liquid crystals, and when the pixel electrode and the common electrode are in the off state, the long axis direction of the liquid crystal molecules in the liquid crystal polymer are parallel to the cell gap direction of the liquid crystal display panel.

Optionally, in the double sided display provided in the embodiment of the present disclosure, in each of the liquid crystal display panels, the pixel electrode and the common electrode are respectively located at both sides of the liquid crystal polymer. In each of the liquid crystal display panels, the common electrodes are located at a side of the first substrate facing the liquid crystal polymer.

Optionally, in the double sided display provided in the embodiment of the present disclosure, in at least one of the liquid crystal display panels, the pixel electrode and the common electrode are both located at the same side of the liquid crystal polymer; liquid crystals in the liquid crystal polymer are positive liquid crystals, and when the pixel electrode and the common electrode are in the off state, the long axis direction of the liquid crystal molecules in the liquid crystal polymer are parallel to the cell gap direction of the liquid crystal display panel. Alternatively, liquid crystals in the liquid crystal polymer are negative liquid crystals, and when the pixel electrode and the common electrode are in the off state, the long axis direction of the liquid crystal molecules in the liquid crystal polymer are perpendicular to the cell gap direction of the liquid crystal display panel.

Optionally, in the double sided display provided in the embodiment of the present disclosure, in the liquid crystal display panels, the pixel electrode and the common electrode are both located at the same side of the liquid crystal polymer, the pixel electrode and the common electrode are arranged alternately in the same layer.

Optionally, in the double sided display provided in the embodiment of the present disclosure, in the liquid crystal display panels, the pixel electrode and the common electrode are both located at the same side of the liquid crystal polymer, the pixel electrode and the common electrode are arranged in different layers, and the liquid crystal display panels further comprise insulating layers located between the pixel electrode and the common electrode.

Optionally, in the double sided display provided in the embodiment of the present disclosure, in the liquid crystal display panels, the pixel electrode and the common electrode are both located at a side of the second substrate facing the liquid crystal polymer. Alternatively, the pixel electrode and the common electrode are both located at a side of the first substrate facing the liquid crystal polymer.

Optionally, in the double sided display provided in the embodiment of the present disclosure, in the liquid crystal display panels, the pixel electrode and the common electrode are located at the same side of the liquid crystal polymer, the liquid crystal display panels further comprise auxiliary electrodes disposed between the first substrate and the second substrate. The auxiliary electrode and the pixel electrode are respectively located at both sides of the liquid crystal polymer.

Optionally, in the double sided display provided in the embodiment of the present disclosure, the second substrates in the two liquid crystal display panels are the same substrate.

Optionally, the liquid crystal polymer is formed by irradiating a mixture of liquid crystals, polymerizable liquid crystal monomers and photoinitiators with ultraviolet light.

Correspondingly, an embodiment of the present disclosure further provides a display device. The display device comprises any one of the above double sided displays provided in embodiments of the present disclosure.

An embodiment of the present disclosure further provides an electronic equipment including the above-mentioned display device.

According to embodiments of the present disclosure, in each liquid crystal display panel, the liquid crystal polymer can be formed by irradiating the mixture of liquid crystals, polymerizable liquid crystal monomers and photoinitiators with ultraviolet light. After the mixture being irradiated by ultraviolet light, polymerizable liquid crystal monomers will polymerize, and the direction of the polymer long chains is basically consistent with the long axis direction of the liquid crystal molecules. Thus when the pixel electrode and the common electrode are in the on state, they form the electric field which causes the liquid crystal molecules in the liquid crystal polymer to deflect. Due to the effect of a polymer network, the liquid crystal polymer is in the scattering state, which will destroy the condition of total reflection between the two substrates for light from the backlight source. As a result, at least a part of light from the backlight source is emitted from a side of the first substrate after being scattered by the liquid crystal polymer. When the pixel electrode and the common electrode are in the off state, the long axis direction of liquid crystal molecules is consistent with the extension direction of the polymer long chains in the liquid crystal polymer, and the liquid crystal polymer is in a transparent state. Therefore, in the liquid crystal display panels, owing to the on and off states of the electric field, the liquid crystal molecules can rotate or recover so as to realize liquid crystal displaying. However, when the pixel electrode and the common electrode are in the off state, since two polarizers are omitted as compared to the existing liquid crystal display panel, a transmittance of 90% can be achieved; accordingly, the double sided display consisting two such liquid crystal panels has higher transparency compared to the existing double sided displays.

### BRIEF DESCRIPTION OF THE DRAWINGS

FIG. 1 is a first structural schematic diagram of the double sided display provided in an embodiment of the present disclosure;

FIG. 2 is a second structural schematic diagram of the double sided display provided in an embodiment of the present disclosure;

FIG. 3 is a third structural schematic diagram of the double sided display provided in an embodiment of the present disclosure;

FIG. 4 is a fourth structural schematic diagram of the double sided display provided in an embodiment of the present disclosure;

FIG. 5 is a fifth structural schematic diagram of the double sided display provided in an embodiment of the present disclosure;

FIG. 6 is a sixth structural schematic diagram of the double sided display provided in an embodiment of the present disclosure;

FIG. 7 is a seventh structural schematic diagram of the double sided display provided in an embodiment of the present disclosure;

FIG. 8 is an eighth structural schematic diagram of the double sided display provided in an embodiment of the present disclosure;

FIG. 9 is a ninth structural schematic diagram of the double sided display provided in an embodiment of the present disclosure;

FIG. 10 is a tenth structural schematic diagram of the double sided display provided in an embodiment of the present disclosure;

FIG. 11 is an eleventh structural schematic diagram of the double sided display provided in an embodiment of the present disclosure; and

FIG. 12 is a twelfth structural schematic diagram of the double sided display provided in an embodiment of the present disclosure.

### DETAILED DESCRIPTION OF THE DISCLOSURE

In order to make the object, technical solution and advantages of the present disclosure clear, specific implementations of the double sided display and display device provided in the embodiments of the present disclosure will be described in detail below with reference to the drawings.

The shapes and sizes of components in the drawings do not reflect the true proportion of the double sided display, but they are only for the purpose of schematically illustrating the present disclosure.

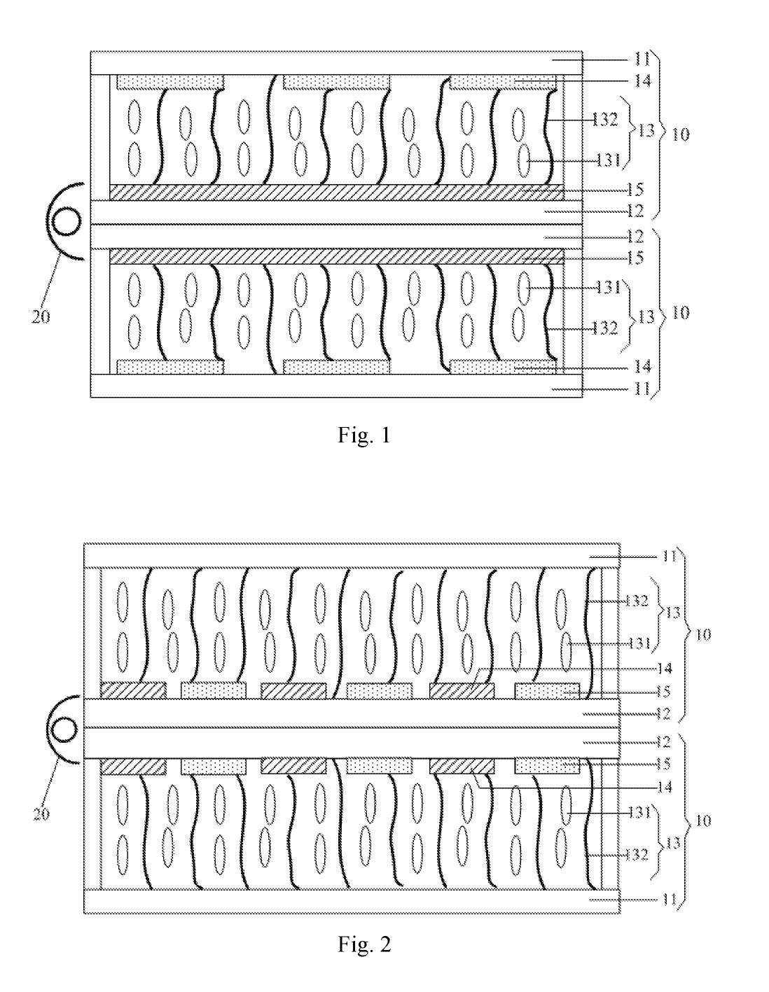

A double sided display is provided by an embodiment of the present disclosure, as shown in FIGS. 1 and 2. The double sided display comprises two liquid crystal display panels 10 laminated on each other with their light exit sides facing away from each other, and side-emitting backlight sources 20 for providing light sources for each of the liquid crystal display panels 10. Each of the liquid crystal display panels 10 comprises: a first substrate 11 and a second substrate 12 opposite to each other, a liquid crystal polymer 13 located between the first substrate 11 and the second substrate 12, a pixel electrode 14 and a common electrode 15 insulated from each other. The liquid crystal polymer 13 comprises polymer long chains 132 arranged along an extension direction. When the pixel electrode 14 and the common electrode 15 are in an off state, a long axis direction of liquid crystal molecules 131 is consistent with the extension direction of the polymer long chains 132 in the liquid crystal polymer 13. When the pixel electrode and the common electrode are in an on state, an electric field is formed by the pixel electrode 14 and the common electrode 15, and the liquid crystal polymer 13 is in a scattering state under the effect of the electric field, so that at least a part of light from the backlight source 20 is emitted from a side of the first substrate 11 after being scattered by the liquid crystal polymer 13, wherein the side of the first substrate 11 is a light exit side of the liquid crystal display panel 10. In this way, in the liquid crystal display panel 10, each sub-area corresponding to the pixel electrode 14 can be switched independently between a bright state and a dark state, thereby realizing dynamic/static display.

In the double sided display provided in the embodiment of the present disclosure, in each liquid crystal display panel, the liquid crystal polymer can be formed by irradiating the mixture of liquid crystals, polymerizable liquid crystal monomers and photoinitiators with ultraviolet light. After the mixture being irradiated by ultraviolet light, polymerizable liquid crystal monomers will polymerize, and the direction of the polymer long chains is basically consistent with the long axis direction of the liquid crystal molecules. Thus when the pixel electrode and the common electrode are in the on state, they form the electric field which causes the liquid crystal molecules in the liquid crystal polymer to deflect. Due to the effect of a polymer network, the liquid crystal polymer is in the scattering state, which will destroy the condition of total reflection between the two substrates for light from the backlight source. As a result, at least a part of light from the backlight source is emitted from a side of the first substrate after being scattered by the liquid crystal polymer. When the pixel electrode and the common electrode are in the off state, the long axis direction of liquid crystal molecules is consistent with the extension direction of the polymer long chains in the liquid crystal polymer, and the liquid crystal polymer is in a transparent state. Therefore, in the liquid crystal display panels, owing to the on and off states of the electric field, the liquid crystal molecules can rotate or recover so as to realize liquid crystal displaying. However, when the pixel electrode and the common electrode are in the off state, since two polarizers are omitted as compared to the existing liquid crystal display panel, a transmittance of 90% can be achieved; accordingly, the double sided display consisting two such liquid crystal panels has higher transparency compared to the existing double sided displays.

Optionally, the liquid crystal polymer is formed by irradiating the mixture of liquid crystals, polymerizable liquid crystal monomers and photoinitiators with ultraviolet light. In the context of this disclosure, the photoinitiator is also called photosensitizer or photocuring agent, which is a kind of compound that can absorb energies of certain wavelengths in the ultraviolet light region (250-420 nm) or the visible light region (400-800 nm) to generate free radicals, cations, etc. so as to cause monomer polymerization crosslinking curing. Appropriate photoinitiators can be methyl benzoylformate (MBF), 2,4,6-trimethylbenzoyl diphenyl-phosphine oxide (TPO), etc., which is not limited herein.

In a specific implementation, in the double sided display provided in the embodiment of the present disclosure, in the mixture of liquid crystals, polymerizable liquid crystal monomers and photoinitiators, content of the polymerizable liquid crystal monomers is generally limited between 1% and 5%, and content of the photoinitiators is generally limited between 0.5% and 3%.

In a specific implementation, the liquid crystals can be positive or negative liquid crystals. When electron withdrawing groups are at an end of the long axis of the liquid crystal molecules, a dielectric constant Δε is greater than 0 and the liquid crystals are positive. When electron withdrawing groups are at an end of a short axis of the liquid crystal molecules, the dielectric constant Δε is smaller than 0 and the liquid crystals are negative. Under the effect of the electric field, the positive liquid crystals and negative liquid crystals will rotate. When the positive liquid crystals are influenced by the electric field, the long axis direction of the liquid crystal molecules are arranged along the direction of the electric field. When the negative liquid crystals are influenced by the electric field, the short axis direction of the liquid crystal molecules are arranged along the direction of the electric field.

In a specific implementation, in the liquid crystal display panels of the double sided display provided in the embodiment of the present disclosure, the pixel electrode and the common electrode can be respectively located at both sides of the liquid crystal polymer. Of course, the pixel electrode and the common electrode can be located at the same side of the liquid crystal polymer, which is not limited herein.

In the double sided display provided in the embodiment of the present disclosure, it is possible that in two liquid crystal display panels, the pixel electrode and the common electrode are respectively located at both sides of the liquid crystal polymer; it is also possible that in two liquid crystal display panels, the pixel electrode and the common electrode are located at the same side of the liquid crystal polymer. Of course, it is also possible that in one of the liquid crystal display panels, the pixel electrode and the common electrode are respectively located at both sides of the liquid crystal polymer, while in the other liquid crystal display panel, the pixel electrode and the common electrode are located at the same side of the liquid crystal polymer.

Further, in the double sided display provided in the embodiment of the present disclosure, when the pixel electrode and the common electrode are located at the same side of the liquid crystal polymer in the liquid crystal display panels, the pixel electrode and the common electrode can be both located at the side of the first substrate facing the liquid crystal polymer. Of course, the pixel electrode and the common electrode can be both located at the side of the second substrate facing the liquid crystal polymer, which is not limited herein.

Further, in the double sided display provided in the embodiment of the present disclosure, when the pixel electrode and the common electrode are located at the same side of the liquid crystal polymer in the liquid crystal display panels, the pixel electrode can be located between the common electrode and the liquid crystal polymer. Of course, the common electrode can be located between the pixel electrode and the liquid crystal polymer, which is not limited herein.

In a specific implementation, in the liquid crystal display panels 10, as shown in FIG. 1, the pixel electrode 14 and the common electrode 15 are respectively located at both sides of the liquid crystal polymer 13, if the pixel electrode 14 and the common electrode 15 are in the on state, they mainly form a vertical electric field (i.e. an electric field perpendicular to the liquid crystal display panels).

When the liquid crystals in the liquid crystal polymer are positive liquid crystals, if the pixel electrode and the common electrode are in the off state, the long axis direction of liquid crystal molecules in the liquid crystal polymer are perpendicular to the cell gap direction of the liquid crystal display panels; thus when the pixel electrode and the common electrode are in the on state, the long axis direction of the liquid crystal molecules in the liquid crystal polymer are arranged along a direction perpendicular to the cell gap direction under the effect of the vertical electric field.

When the liquid crystals in the liquid crystal polymer 13 are negative liquid crystals, as shown in FIG. 1, if the pixel electrode 14 and the common electrode 15 are in the off state, the long axis direction of liquid crystal molecules 131 in the liquid crystal polymer 13 are parallel to the cell gap direction of the liquid crystal display panels 10; thus when the pixel electrode 14 and the common electrode 15 are in the on state, the long axis direction of the liquid crystal molecules 131 in the liquid crystal polymer 13 are arranged along the cell gap direction under the effect of the vertical electric field.

In a specific implementation, in the liquid crystal display panels 10, as shown in FIG. 2, when the pixel electrode 14 and the common electrode 15 are both located at the same side of the liquid crystal polymer 13, if the pixel electrode 14 and the common electrode 15 are in the on state, they mainly form a horizontal electric field.

When the liquid crystals in the liquid crystal polymer 13 are positive liquid crystals, as shown in FIG. 2, if the pixel electrode 14 and the common electrode 15 are in the off state, the long axis direction of liquid crystal molecules 131 in the liquid crystal polymer 13 are parallel to the cell gap direction of the liquid crystal display panels 10; thus when the pixel electrode 14 and the common electrode 15 are in the on state, the long axis direction of the liquid crystal molecules 131 in the liquid crystal polymer 13 are arranged along a direction perpendicular to the cell gap direction under the effect of the horizontal electric field.

When the liquid crystals in the liquid crystal polymer are negative liquid crystals, as far as the structure shown in FIG. 2 is concerned, if the pixel electrode 14 and the common electrode 15 are in the off state, the long axis direction of liquid crystal molecules in the liquid crystal polymer are perpendicular to the cell gap direction of the liquid crystal display panels; thus when the pixel electrode 14 and the common electrode 15 are in the on state, the long axis direction of the liquid crystal molecules in the liquid crystal polymer are arranged along the cell gap direction under the effect of the horizontal electric field. In this embodiment, the direction of the polymer long chains is perpendicular to the cell gap direction of the liquid crystal display panels, thereby achieving the same display effect as that described in the above embodiment.

Further, in a specific implementation, in the double sided display provided in the embodiment of the present disclosure, when the pixel electrode and the common electrode are in the off state, the long axis direction of the liquid crystal molecules in the liquid crystal polymer are perpendicular to the cell gap direction of the liquid crystal display panels. In such an arrangement, a vertically orientation material is usually used to perform vertically orientation processing to the substrates.

Similarly, when the pixel electrode and the common electrode are in the off state, the long axis direction of the liquid crystal molecules in the liquid crystal polymer are along the cell gap direction of the liquid crystal display panels. In such an arrangement, a horizontally orientation material is usually used to perform horizontally orientation processing to the substrates.

It shall be noted that in the double sided display provided in the embodiment of the present disclosure, as is known to those skilled in the art, the long axis direction of the liquid crystal molecules in the liquid crystal polymer being consistent with the extension direction of the polymer long chains means that the direction are substantially consistent, but it can also mean complete consistency in strict sense. Likewise, the long axis direction of the liquid crystal molecules being parallel or perpendicular to the cell gap direction of the liquid crystal display panels means that the direction are approximately parallel or perpendicular, but it can also mean to be exactly parallel or perpendicular.

Further, in the double sided display provided in the embodiment of the present disclosure, since the two liquid crystal display panels are independent, either one liquid crystal display panel can be controlled independently for realizing single sided display, or the two liquid crystal display panels can be controlled simultaneously for realizing doubled sided display, which is not limited herein.

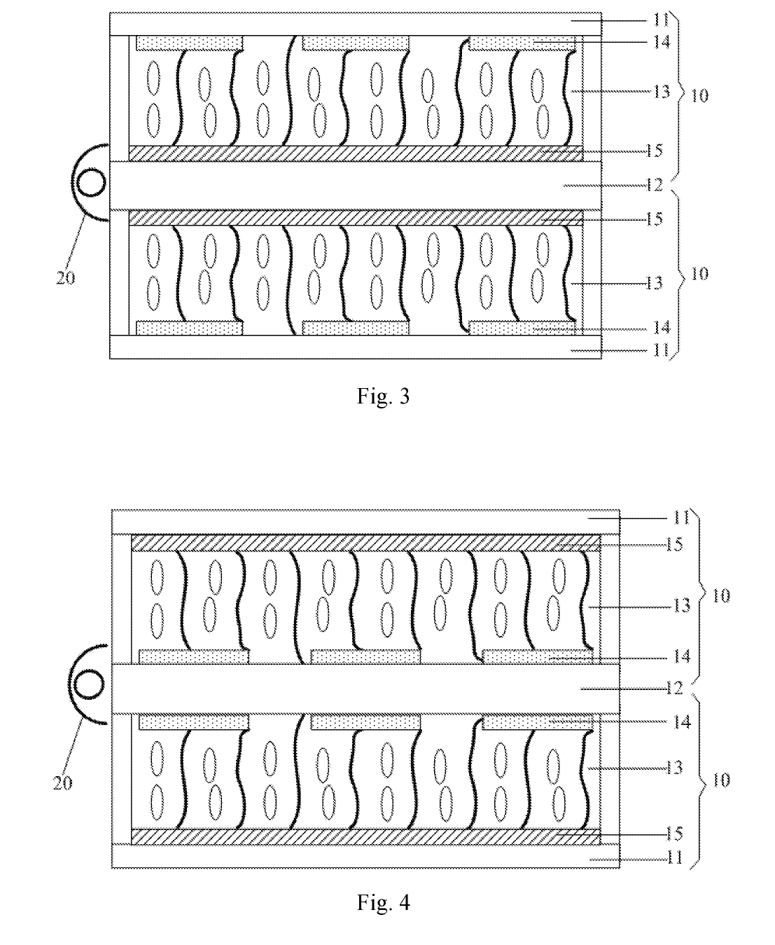

Optionally, in the double sided display provided in the embodiment of the present disclosure, in order to reduce the entire thickness, as shown in FIGS. 3-12, the second substrates 12 in the two liquid crystal display panels 10 are the same substrate.

It shall be further noted that although the liquid crystal display panels provided in the embodiment of the present disclosure do not include polarizers, they include other films and structures for realizing liquid crystal display, such as thin film transistors, color film layers, black matrix layers, spacers, etc., and settings of the films and structures are the same as those in the prior art, so they will not be elaborated herein.

Further, in the double sided display provided in the embodiment of the present disclosure, as shown in FIGS. 1-9, the backlight sources 20 only include one light source which is located on a side of the second substrate 12, and such backlight sources may not have high light incident efficiency. The light incident efficiency refers to a ratio of the light among the backlight sources that are totally reflected after entering the two liquid crystal display panels.

Therefore, optionally, in the double sided display provided in the embodiment of the present disclosure, as shown in FIGS. 10-12, the backlight sources 20 includes two light sources which are respectively on the sides of the liquid crystal polymers 13 of the two liquid crystal display panels 10.

The double sided display provided in the embodiments of the present disclosure will be described below by means of specific embodiments.

### Embodiment 1

In a specific implementation, in the double sided display provided in the embodiment of the present disclosure, as shown in FIGS. 1 and 3, in the two liquid crystal display panels 10, the pixel electrode 14 and the common electrode 15 are respectively located at both sides of the liquid crystal polymer 13. In the two liquid crystal display panels 10, the pixel electrodes 14 are all located at the side of the first substrate 11 facing the liquid crystal polymer 13, and the common electrodes 15 are all located at the side of the second substrate 12 facing the liquid crystal polymer 13.

### Embodiment 2

In a specific implementation, in the double sided display provided in the embodiment of the present disclosure, as shown in FIG. 4, in the two liquid crystal display panels 10, the pixel electrode 14 and the common electrode 15 are respectively located at both sides of the liquid crystal polymer 13. In the two liquid crystal display panels 10, the common electrodes 15 are all located at the side of the first substrate 11 facing the liquid crystal polymer 13, and the pixel electrodes 14 are all located at the side of the second substrate 12 facing the liquid crystal polymer 13. In this case, the common electrode 15 can shield interferences from external signals, thereby enhancing the capability of the double sided display in resisting external signal interferences.

### Embodiment 3

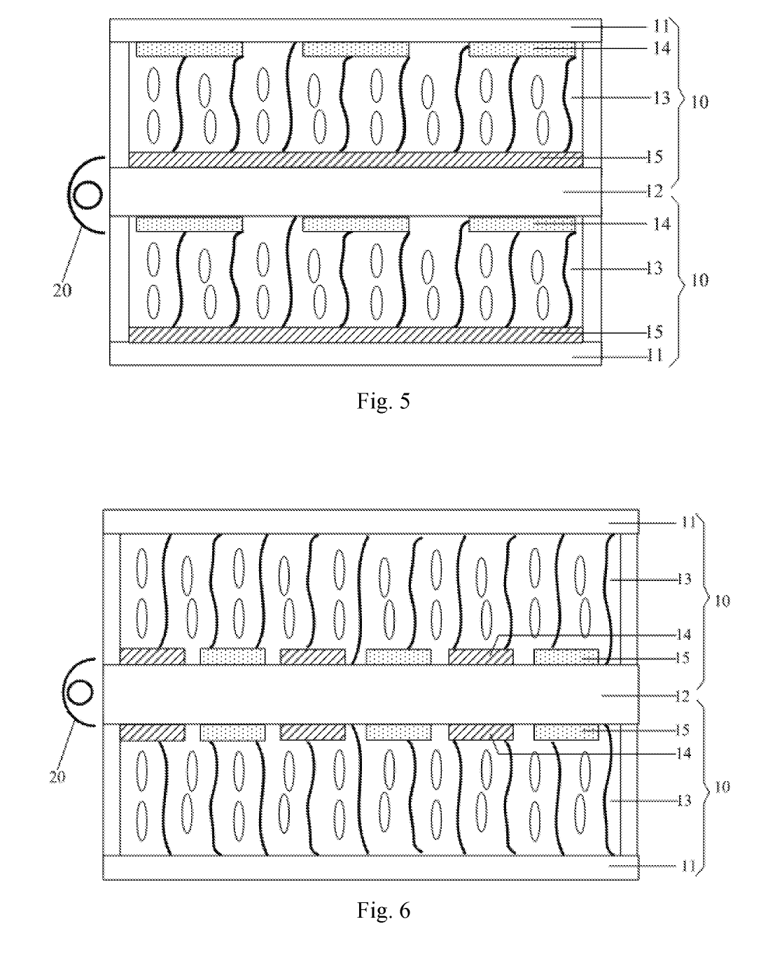

In a specific implementation, in the double sided display provided in the embodiment of the present disclosure, as shown in FIG. 5, in the two liquid crystal display panels 10, the pixel electrode 14 and the common electrode 15 are respectively located at both sides of the liquid crystal polymer 13. In one of the liquid crystal display panels 10, the common electrodes 15 are located at the side of the liquid crystal polymer 13 facing the first substrate 11, while the pixel electrodes 14 are located at the side of the second substrate 12 facing the liquid crystal polymer 13; in the other liquid crystal display panel 10, the pixel electrodes 14 are located at the side of the first substrate 11 facing the liquid crystal polymer 13, while the common electrodes 15 are located at the side of the liquid crystal polymer 13 facing the second substrate 12.

### Embodiment 4

In a specific implementation, in the double sided display provided in the embodiment of the present disclosure, as shown in FIGS. 2, 6 and 10, in the two liquid crystal display panels 10, when the pixel electrode 14 and the common electrode 15 are both located at the same side of the liquid crystal polymer 13, the pixel electrode 14 and the common electrode 15 are arranged alternately in the same layer.

Further, as shown in FIGS. 2, 6 and 10, the pixel electrode 14 and the common electrode 15 can be located at the side of the second substrate 12 facing the liquid crystal polymer 13. Of course, the pixel electrode 14 and the common electrode 15 can also be located at the side of the first substrate 11 facing the liquid crystal polymer 13, which is not limited herein.

Further, in a specific implementation, the pixel electrode and the common electrode can both be strip electrodes, which is not limited herein.

### Embodiment 5

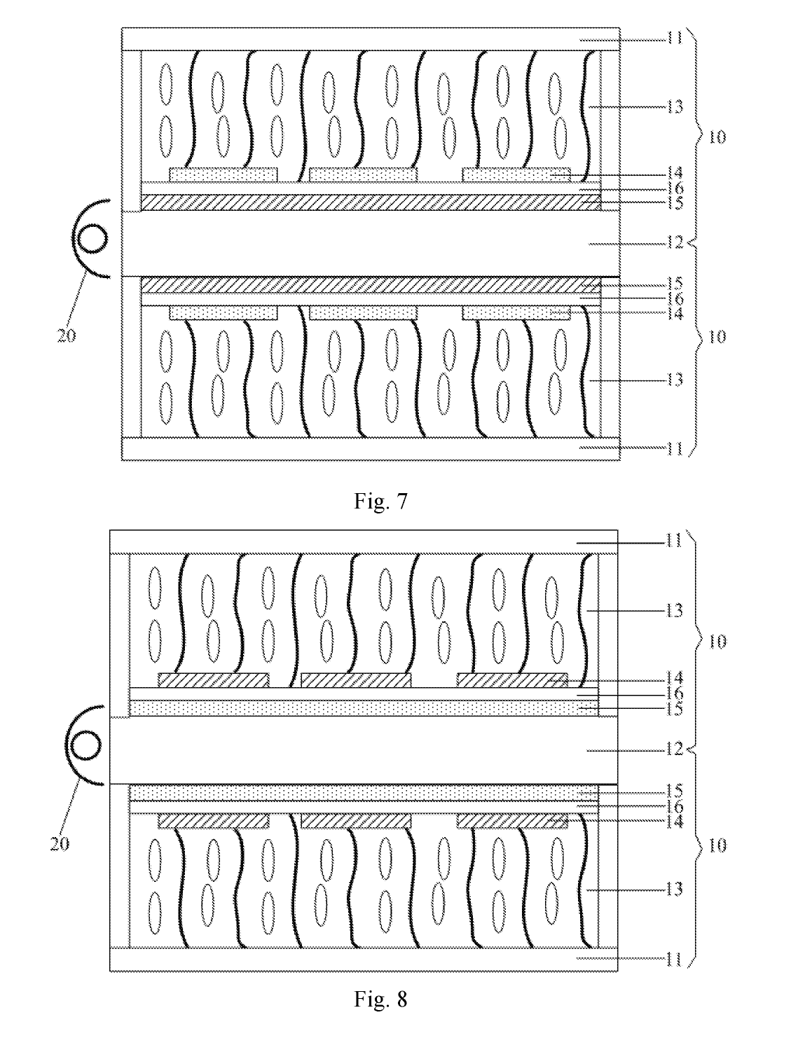

In a specific implementation, in the double sided display provided in the embodiment of the present disclosure, as shown in FIGS. 7, 8 and 11, in the two liquid crystal display panels 10, when the pixel electrode 14 and the common electrode 15 are both located at the same side of the liquid crystal polymer 13, the pixel electrode 14 and the common electrode 15 are arranged in different layers, and the liquid crystal display panels 10 further comprise insulating layers 16 located between the pixel electrode 14 and the common electrode 15.

In a specific implementation, as shown in FIGS. 7, 8 and 11, the pixel electrode 14 and the common electrode 15 can both be located at the side of the second substrate 12 facing the liquid crystal polymer 13.

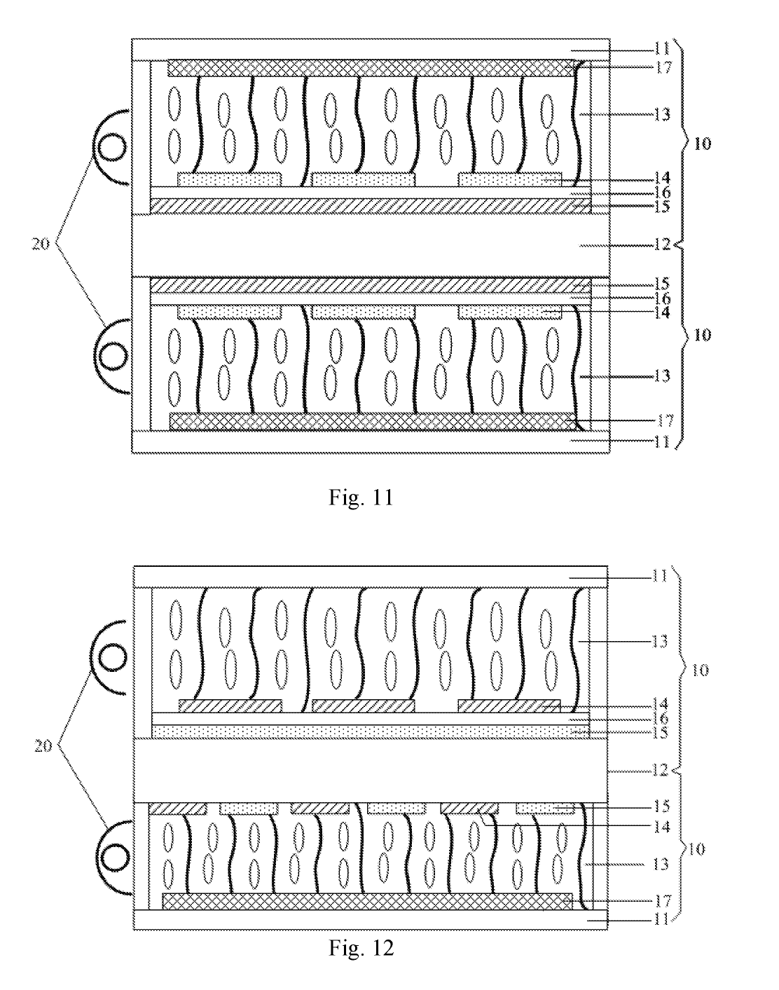

Further, in the double sided display provided in the embodiment of the present disclosure, as shown in FIGS. 7 and 11, the pixel electrodes 14 are located between the insulating layer 16 and the second substrate 12, and the common electrodes 15 are located between the insulating layer 16 and the liquid crystal polymer 13.

In a specific implementation, the common electrode can be a strip electrode or slit electrode, and the pixel electrode can be a planar electrode, which are not limited herein.

Optionally, further, in the double sided display provided in the embodiment of the present disclosure, as shown in FIG. 8, the common electrodes 15 are located between the insulating layer 16 and the second substrate 12, and the pixel electrodes 14 are located between the insulating layer 16 and the liquid crystal polymer 13.

In a specific implementation, the pixel electrode can be a strip electrode or slit electrode, and the common electrode can be a planar electrode, which are not limited herein.

Of course, in a specific implementation, the pixel electrode and the common electrode can both be located at the side of the first substrate facing the liquid crystal polymer.

Further, in the double sided display provided in the embodiment of the present disclosure, the pixel electrodes are located between the insulating layer and the first substrate, and the common electrodes are located between the insulating layer and the liquid crystal polymer. In this case, the common electrode can be a strip electrode or slit electrode, and the pixel electrode can be a planar electrode, which are not limited herein.

Optionally, further, in the double sided display provided in the embodiment of the present disclosure, the common electrodes are located between the insulating layer and the first substrate, and the pixel electrodes are located between the insulating layer and the liquid crystal polymer. In this case, the pixel electrode can be a strip electrode or slit electrode, and the common electrode can be a planar electrode, which are not limited herein.

### Embodiment 6

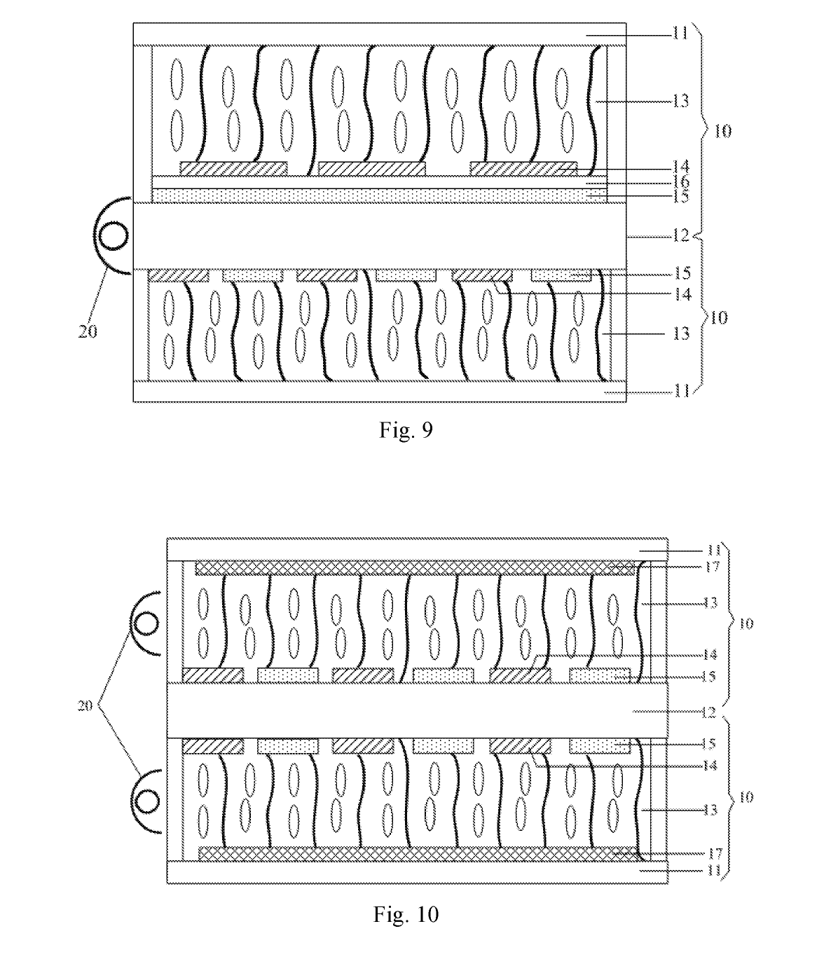

In a specific implementation, in the double sided display provided in the embodiment of the present disclosure, as shown in FIGS. 9 and 12, in the two liquid crystal display panels 10, when the pixel electrode 14 and the common electrode 15 are both located at the same side of the liquid crystal polymer 13, in one of the liquid crystal display panels 10, the pixel electrode 14 and the common electrode 15 are arranged in different layers, and the liquid crystal display panel 10 further comprises the insulating layer 16 disposed between the pixel electrode 14 and the common electrode 15; in the other liquid crystal display panels 10, the pixel electrode 14 and the common electrode 15 are arranged alternately in the same layer.

### Embodiment 7

In the double sided display provided in the embodiment of the present disclosure, as shown in FIGS. 10-12, in the liquid crystal display panels 10, when the pixel electrode 14 and the common electrode 15 are both located at the same side of the liquid crystal polymer 13, the liquid crystal display panels 10 further comprise auxiliary electrodes 17 located between the first substrate 11 and the second substrate 12. The auxiliary electrode and the pixel electrode 14 are respectively located at both sides of the liquid crystal polymer 13. The auxiliary electrode 17 is used for regulating the electric field formed by the pixel electrode 14 and the common electrode 15 so that it can have more horizontal components, i.e. the auxiliary electrode 17 is used for increasing the horizontal components of the electric field formed by the pixel electrode 14 and the common electrode 15.

It shall be noted that in the double sided display provided in the embodiment of the present disclosure, one liquid crystal display panel comprises several pixel units. Usually, one pixel unit corresponds to one pixel electrode, and one liquid crystal display panel corresponds to one auxiliary electrode.

Based on the same inventive concept, an embodiment of the present disclosure further provides a display device, comprising any one of the above-described double sided displays provided in the embodiments of the present disclosure. The problem-solving principle of the display device is similar to that of the above-described double sided display, so implementation of the display device is similar to the implementation of the above-described double sided display, and the repetitions will not be elaborated any more.

An embodiment of the present disclosure further provides an electronic equipment, comprising the above-mentioned display device.

According to embodiments of the present disclosure, in each liquid crystal display panel, the liquid crystal polymer can be formed by irradiating the mixture of liquid crystals, polymerizable liquid crystal monomers and photoinitiators with ultraviolet light. After the mixture being irradiated by ultraviolet light, polymerizable liquid crystal monomers will polymerize, and the direction of the polymer long chains is basically consistent with the long axis direction of the liquid crystal molecules. Thus when the pixel electrode and the common electrode are in the on state, they form the electric field which causes the liquid crystal molecules in the liquid crystal polymer to deflect. Due to the effect of a polymer network, the liquid crystal polymer is in the scattering state, which will destroy the condition of total reflection between the two substrates for light from the backlight source. As a result, at least a part of light from the backlight source is emitted from a side of the first substrate after being scattered by the liquid crystal polymer. When the pixel electrode and the common electrode are in the off state, the long axis direction of liquid crystal molecules is consistent with the extension direction of the polymer long chains in the liquid crystal polymer, and the liquid crystal polymer is in a transparent state. Therefore, in the liquid crystal display panels, owing to the on and off states of the electric field, the liquid crystal molecules can rotate or recover so as to realize liquid crystal displaying. However, when the pixel electrode and the common electrode are in the off state, since two polarizers are omitted as compared to the existing liquid crystal display panel, a transmittance of 90% can be achieved; accordingly, the double sided display consisting two such liquid crystal panels has higher transparency compared to the existing double sided displays.

Apparently, those skilled in the art can make various changes and modifications to the present disclosure without departing from the spirit and scope of the present disclosure. Therefore, if the changes and modifications fall within the scope of the claims of the disclosure and their equivalents, then they should be included in the present disclosure.

1. A double sided display, which comprises two liquid crystal display panels laminated on each other with their light exit sides facing away from each other, and a side-emitting backlight source for providing light for each of the liquid crystal display panels,
wherein each liquid crystal display panel comprises:
a first substrate and a second substrate arranged opposite to each other, a liquid crystal polymer located between the first substrate and the second substrate, a pixel electrode and a common electrode insulated from each other; wherein the liquid crystal polymer comprises polymer long chains arranged along an extension direction;
when the pixel electrode and the common electrode are in an off state, a long axis direction of liquid crystal molecules in the liquid crystal polymer is consistent with the extension direction of the polymer long chains; when the pixel electrode and the common electrode are in an on state, an electric field is formed by the pixel electrode and the common electrode, and the liquid crystal polymer is in a scattering state under the effect of the electric field, so that at least a part of light from the backlight source is emitted from a side of the first substrate after being scattered by the liquid crystal polymer, wherein the side of the first substrate is a light exit side of the liquid crystal display panel.

2. The double sided display according to claim 1, wherein in at least one of the liquid crystal display panels, the pixel electrode and the common electrode are respectively located at both sides of the liquid crystal polymer;
wherein liquid crystals in the liquid crystal polymer are positive liquid crystals, and when the pixel electrode and the common electrode are in the off state, the long axis direction of the liquid crystal molecules in the liquid crystal polymer are perpendicular to a cell gap direction of the liquid crystal display panel; alternatively, liquid crystals in the liquid crystal polymer are negative liquid crystals, and when the pixel electrode and the common electrode are in the off state, the long axis direction of the liquid crystal molecules in the liquid crystal polymer are parallel to the cell gap direction of the liquid crystal display panel.

3. The double sided display according to claim 2, wherein in each of the liquid crystal display panels, the pixel electrode and the common electrode are respectively located at both sides of the liquid crystal polymer;
and wherein in each of the liquid crystal display panels, the common electrode is located at a side of the first substrate facing the liquid crystal polymer.

4. The double sided display according to claim 1, wherein in at least one of the liquid crystal display panels, the pixel electrode and the common electrode are both located at the same side of the liquid crystal polymer;
wherein liquid crystals in the liquid crystal polymer are positive liquid crystals, and when the pixel electrode and the common electrode are in the off state, the long axis direction of the liquid crystal molecules in the liquid crystal polymer are parallel to the cell gap direction of the liquid crystal display panel; alternatively, liquid crystals in the liquid crystal polymer are negative liquid crystals, and when the pixel electrode and the common electrode are in the off state, the long axis direction of the liquid crystal molecules in the liquid crystal polymer are perpendicular to the cell gap direction of the liquid crystal display panel.

5. The double sided display according to claim 4, wherein in the liquid crystal display panels, the pixel electrode and the common electrode are both located at the same side of the liquid crystal polymer, the pixel electrode and the common electrode are arranged alternately in the same layer.

6. The double sided display according to claim 4, wherein in the liquid crystal display panels, the pixel electrode and the common electrode are both located at the same side of the liquid crystal polymer, the pixel electrode and the common electrode are arranged in different layers, and the liquid crystal display panels further comprise insulating layers located between the pixel electrode and the common electrode.

7. The double sided display according to claim 6, wherein in the liquid crystal display panels, the pixel electrode and the common electrode are both located at a side of the second substrate facing the liquid crystal polymer; alternatively, the pixel electrode and the common electrode are both located at a side of the first substrate facing the liquid crystal polymer.

8. The double sided display according to claim 4, wherein in the liquid crystal display panels, the pixel electrode and the common electrode is located at the same side of the liquid crystal polymer, the liquid crystal display panels further comprise auxiliary electrodes disposed between the first substrate and the second substrate; the auxiliary electrode and the pixel electrode are respectively located at both sides of the liquid crystal polymer.

9. The double sided display according to claim 1, wherein the second substrates in the two liquid crystal display panels are the same substrate.

10. The double sided display according to claim 1, wherein the liquid crystal polymer is formed by irradiating a mixture of liquid crystals, polymerizable liquid crystal monomers and photoinitiators with ultraviolet light.

11. A display device, comprising the double sided display according to claim 1.

12. An electronic equipment, comprising the display device according to claim

11.

13. The electronic equipment according to claim 12, wherein in at least one of the liquid crystal display panels, the pixel electrode and the common electrode are respectively located at both sides of the liquid crystal polymer;
wherein liquid crystals in the liquid crystal polymer are positive liquid crystals, and when the pixel electrode and the common electrode are in the off state, the long axis direction of the liquid crystal molecules in the liquid crystal polymer are perpendicular to a cell gap direction of the liquid crystal display panel; alternatively, liquid crystals in the liquid crystal polymer are negative liquid crystals, and when the pixel electrode and the common electrode are in the off state, the long axis direction of the liquid crystal molecules in the liquid crystal polymer are parallel to the cell gap direction of the liquid crystal display panel.

14. The electronic equipment according to claim 13, wherein in each of the liquid crystal display panels, the pixel electrode and the common electrode are respectively located at both sides of the liquid crystal polymer;
and wherein in each of the liquid crystal display panels, the common electrode is located at a side of the first substrate facing the liquid crystal polymer.

15. The electronic equipment according to claim 12, wherein in at least one of the liquid crystal display panels, the pixel electrode and the common electrode are both located at the same side of the liquid crystal polymer;
wherein liquid crystals in the liquid crystal polymer are positive liquid crystals, and when the pixel electrode and the common electrode are in the off state, the long axis direction of the liquid crystal molecules in the liquid crystal polymer are parallel to the cell gap direction of the liquid crystal display panel; alternatively, liquid crystals in the liquid crystal polymer are negative liquid crystals, and when the pixel electrode and the common electrode are in the off state, the long axis direction of the liquid crystal molecules in the liquid crystal polymer are perpendicular to the cell gap direction of the liquid crystal display panel.

16. The electronic equipment according to claim 15, wherein in the liquid crystal display panels, the pixel electrode and the common electrode are both located at the same side of the liquid crystal polymer, the pixel electrode and the common electrode are arranged alternately in the same layer.

17. The electronic equipment according to claim 15, wherein in the liquid crystal display panels, the pixel electrode and the common electrode are both located at the same side of the liquid crystal polymer, the pixel electrode and the common electrode are arranged in different layers, and the liquid crystal display panels further comprise insulating layers located between the pixel electrode and the common electrode.

18. The electronic equipment according to claim 17, wherein in the liquid crystal display panels, the pixel electrode and the common electrode are both located at a side of the second substrate facing the liquid crystal polymer; alternatively, the pixel electrode and the common electrode are both located at a side of the first substrate facing the liquid crystal polymer.

19. The electronic equipment according to claim 15, wherein in the liquid crystal display panels, the pixel electrode and the common electrode is located at the same side of the liquid crystal polymer, the liquid crystal display panels further comprise auxiliary electrodes disposed between the first substrate and the second substrate; the auxiliary electrode and the pixel electrode are respectively located at both sides of the liquid crystal polymer.

20. The electronic equipment according to claim 12, wherein the second substrates in the two liquid crystal display panels are the same substrate.
